(19) United States
(12) Patent Application Publication
(10) Pub. No.: US 2017/0332249 A1
(43) Pub. Date: Nov. 16, 2017

(54) Methods and Apparatus for Generating Beam Pattern with Wider Beam Width in Phased Antenna Array

(71) Applicant: MEDIATEK INC., Hsinchu (TW)

(72) Inventors: Jiann-Ching Guey, Hsinchu City (TW); Ming-Po Chang, New Taipei City (TW); Ju-Ya Chen, Kaohsiung City (TW)

(21) Appl. No.: 15/589,052

(22) Filed: May 8, 2017

Related U.S. Application Data
(60) Provisional application No. 62/334,475, filed on May 11, 2016.

(51) Int. Cl. H04W 16/28; H04B 7/06; H04W 72/04; H04W 84/04

(52) U.S. Cl. CPC H04W 16/28; H04W 72/046; H04B 7/0617; H04W 84/042

(57) ABSTRACT

A method of steering beam direction and shaping beamwidth of a directional beam using a phased antenna array in a beamforming cellular system is proposed. The N antenna elements of the phased antenna array are applied with a set of combined beam coefficients to steer the direction of the beam and to shape the beamwidth to a desired width. Specifically, in addition to the original constant phase shift values, additional phase modulations are applied to expand the beam to a desirable width. The phased antenna array applied with the combined beam coefficients involve only phase shift, no amplitude modulation is needed and thereby increasing beamforming gain and efficiency.

### CROSS REFERENCE TO RELATED APPLICATIONS

This application claims priority under 35 U.S.C. §119 from U.S. Provisional Application No. 62/334,475, entitled “Methods and Apparatus for Generating Beam Pattern with Wider Beam Width in Phased Antenna Array,” filed on May 11, 2016; the subject matter of which is incorporated herein by reference.

### TECHNICAL FIELD

The disclosed embodiments relate generally to wireless communication, and, more particularly, to generating beam pattern with wider beam width in phased antenna array.

### BACKGROUND

In antenna theory, a phased antenna array usually means an array of antennas that creates a beam of radio waves can be electronically steered to point in different directions, without moving the antennas. In the phased antenna array, the radio frequency current from the transmitter is fed to the individual antennas with the correct phase relationship so that the radio waves from the separate antennas add together to increase the radiation in a desired direction, while cancelling to suppress radiation in undesired directions. In the phased antenna array, the power from the transmitter is fed to the antennas through phase shifters, controlled by a processor, which can alter the phase electronically, thus steering the beam of radio waves to a different direction.

Phased array antennas can form narrowly focused beam. In a most prevalent configuration, N antenna elements forms a Uniform Linear Array with half a wavelength spacing. A constant phase shift from one element to next determines the direction the beam is pointing to. The beamwidth and beamforming gain are functions of the array configuration including: the number of antenna elements N, the spacing between adjacent elements, and the carrier frequency of the radio signal. Once the configuration is fixed, the beamwidth formed by the constant phase shift steering coefficients is determined. For example, the beamwidth=103°/N. Sometimes it is desirable to set the coefficients in a way such that the beamwidth is wider than the one generated by this conventional configuration, e.g., to broaden the coverage area of the beam. The same issue occurs in both transmit and receive beamforming.

A simple way of solving this problem is to use only a subset of the antenna elements. Using the first half of the antenna elements would typically form a beam pattern with twice the beamwidth. However, using only a subset of the antenna elements may reduce the total transmit power. If each antenna element has a power amplifier, shutting off an antenna element means a reduction in total transmit power. A slightly sophisticated method is to change not only the phase of the signal feeding into an antenna element but also its amplitude. The amplitude applied across the antenna elements are sometimes derived from a windowing function such as Hamming window. Applying windowing on the amplitude of the signals feeding into the antenna requires each antenna element has a power amplifier. Amplitude windowing essentially reduces the transmit/receive power of the array and is not efficient.

A solution is sought.

### SUMMARY

A method of steering beam direction and shaping beamwidth of a directional beam using a phased antenna array in a beamforming cellular system is proposed. The N antenna elements of the phased antenna array are applied with a set of combined beam coefficients to steer the direction of the beam and to shape the beamwidth to a desired width. Specifically, in addition to the original constant phase shift values, additional phase modulations are applied to expand the beam to a desirable width. The original phase shift values are referred to as the beam steering coefficients, which are used to steer the direction of the directional beam. The additional phase modulations are referred to as the beam expansion coefficients, which are used to shape the width of the directional beam. The phased antenna array applied with the combined beam coefficients involve only phase shift, no amplitude modulation is needed and thereby increasing beamforming gain and efficiency.

In one embodiment, a wireless device transmits or receives a radio signal over a directional beam using a phased antenna array having N antenna elements in a beamforming cellular network. Adjacent antenna elements have a distance of d, and N is a positive integer. The wireless device applies a plurality of phase shift values to the plurality of antenna elements, each antenna element is applied with a phase shift value having a combined beam coefficient. Each combined beam coefficient comprises a beam steering coefficient plus a beam expansion coefficient. The wireless device steers a direction of the directional beam and shapes a beamwidth of the directional beam by controlling the combined beam coefficients by a processor. The beam steering coefficients are used to steer the direction of the directional beam, while the beam expansion coefficients are used to shape the beamwidth of the directional beam.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a wireless device having a phased antenna array for transmitting or receiving a directional beam with a wider beamwidth in a beamforming cellular mobile communication network in accordance with one novel aspect.

FIG. 2 is a simplified block diagram of a base station or a user equipment that carry out certain embodiments of the present invention.

FIG. 3 illustrates a one embodiment of a transmitter or receiver having a phased antenna array with N antenna elements to transmit or receive a directional beam, each antenna element is applied with a combined beam coefficient to steer the beam direction and to shape the beamwidth of the directional beam.

FIG. 4 illustrates the array gain and azimuth angle of phased antenna array by comparing conventional beamforming, beamforming with beam expansion, and beamforming with rectangular window.

FIG. 5 is a flow chart of a method of steering beam direction and shaping beamwidth of a directional beam using a phased antenna array in a beamforming cellular system in accordance with one novel aspect.

### DETAILED DESCRIPTION

Reference will now be made in detail to some embodiments of the invention, examples of which are illustrated in the accompanying drawings.

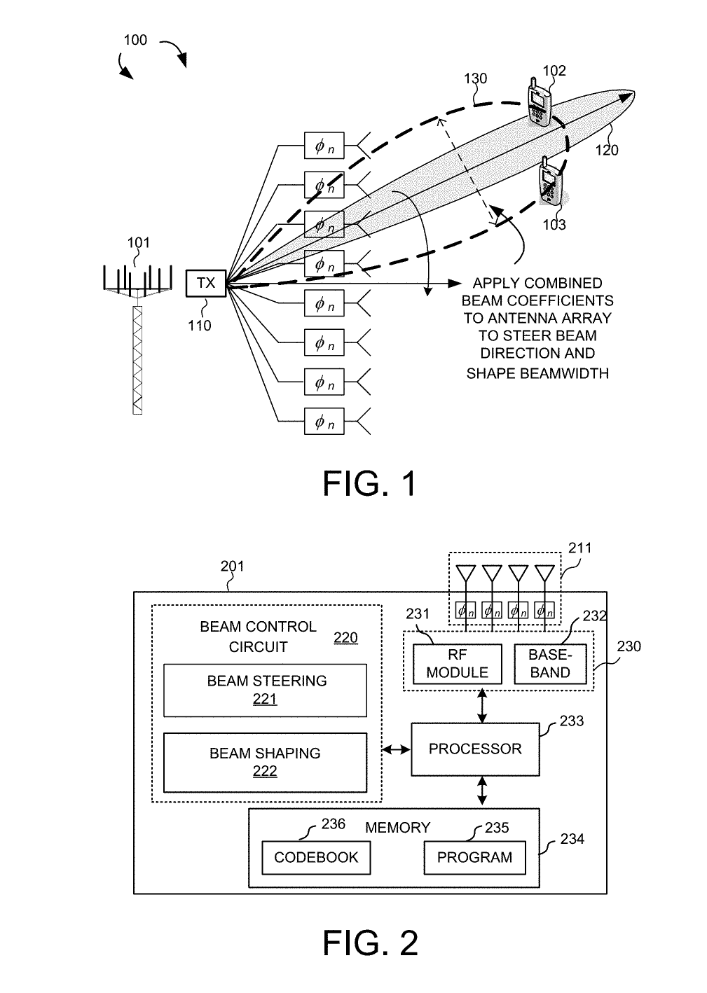

FIG. 1 illustrates a wireless device having a phased antenna array for transmitting or receiving a directional beam with a wider beamwidth in a beamforming cellular mobile communication network 100 in accordance with one novel aspect. Beamforming cellular mobile communication network 100 comprises a base station BS 101 and a first user equipment UE 102 and a second user equipment UE 103. The cellular network uses directional communications with narrow beams and can support multi-gigabit data rate. Directional communications are achieved via beamforming, wherein a phased antenna array having multiple antenna elements are applied with multiple sets of beamforming weights (phase shift values) to form multiple beam patterns.

In the example of FIG. 1, BS 101 is directionally configured with a set of coarse TX/RX control beams and a set of dedicated TX/RX data beams to serve mobile stations including UE 102 and UE 103. Typically, the collection of the control beams covers an entire service area of a serving cell, and each control beam has a wider and shorter spatial coverage with smaller array gain. Each control beam in turn is covered by a set of dedicated data beams. The collection of the dedicated data beams covers a service area of one control beam, and each dedicated data beam has a narrower and longer spatial coverage with larger array gain. The set of control beams provides low rate control signaling to facilitate high rate data communication on dedicated data beams. Similarly, UE 102 and UE 103 may also apply beamforming to from multiple beam patterns to transmit and receive radio signals.

Phased array antennas can form narrowly focused beam. In a most prevalent configuration, N antenna elements forms a Uniform Linear Array with half a wavelength spacing. A constant phase shift from one element to next determines the direction the beam is pointing to. The beamwidth and beamforming gain are functions of the array configuration including: the number of antenna elements N, the spacing between adjacent elements, and the carrier frequency of the radio signal. Once the configuration is fixed, the beamwidth formed by the constant phase shift steering coefficients is determined. For example, the beamwidth=103°/N. Sometimes it is desirable to set the coefficients in a way such that the beamwidth is wider than the one generated by this conventional configuration, e.g., to broaden the coverage area of the beam. The same issue occurs in both transmit and receive beamforming. For example, it is desirable to have BS 101 to be configured with a set of coarse control beams with wider beamwidth, so that the collection of the control beams can cover the entire service area of the serving cell.

In according with one novel aspect, a method of steering beam direction and shaping beamwidth of a directional beam using a phased antenna array in a beamforming cellular system is proposed. In the example of FIG. 1, BS 101 comprises a transmitter TX 110 coupled to a phased antenna array having N antenna elements, with antenna index n=0, 1, . . . N−1. The N antenna elements forms a Uniform Linear Array with half a wavelength spacing. The N antenna elements are applied with a set of combined beam coefficients Φn to steer the direction of the beam and to shape the beamwidth to a desired width. Specifically, in addition to the original constant phase shift values φₙ from one antenna element to the next antenna element, additional phase modulation θn is applied to expand the beam to a desirable width. The original phase shift values φₙ are referred to as the beam steering coefficients, which are used to steer the direction of the beam. The additional phase modulation θn are referred to as the beam expansion coefficients, which are used to shape the width of the beam. The phased antenna array applied with the combined beam coefficients Φn involve only phase shift, no amplitude modulation is needed and thereby increasing beamforming gain and efficiency. In one example, the antenna array is applied with the original constant phase shift values to form a dedicated beam 120 with narrower beamwidth for data communication between BS 101 and UE 102. On the other hand, the antenna array is applied with the combined beam coefficients to form a control beam 130 with wider beamwidth, which can be used to transmit control signaling and system information from BS 101 to both UE 102 and UE 103.

FIG. 2 is a simplified block diagram of a wireless device 201 that carries out certain embodiments of the present invention. Device 201 has a phased antenna array 211 having multiple antenna elements that transmits and receives radio signals, a transceiver 230 comprising one or more RF transceiver modules 231 and a baseband processing unit 232, coupled with the phased antenna array, receives RF signals from antenna 211, converts them to baseband signal, and sends them to processor 233. RF transceiver 231 also converts received baseband signals from processor 233, converts them to RF signals, and sends out to antenna 211. Processor 233 processes the received baseband signals and invokes different functional modules and circuits to perform features in BS 201. Memory 234 stores program instructions and data 235 to control the operations of device 201. The program instructions and data 235, when executed by processor 233, enables device 201 to apply various beamforming weights to multiple antenna elements of antenna 211 and form various beams.

Device 201 also includes multiple function modules and circuits that carry out different tasks in accordance with embodiments of the current invention. The functional modules and circuits can be implemented and configured by hardware, firmware, software, and any combination thereof. For example, device 201 comprises a beam control circuit 220, which further comprises a beam direction steering circuit 221 that steers the direction of the beam and a beamwidth shaping circuit 222 that shapes the beamwidth of the beam. Beam control circuit 220 may belong to part of the RF chain, which applies various beamforming weights to multiple antenna elements of antenna 211 and thereby forming various beams. Based on phased array reciprocity or channel reciprocity, the same receiving antenna pattern can be used for transmitting antenna pattern. In one example, beam control circuit 220 applies additional phase modulation to the original phase shift values that form a directional beam pattern with a desirable width. Beam steering circuit 221 applies the original phase shift values that form a directional narrow beam pattern. Beam shaping circuit 222 applies the additional phase modulation that expands the narrow beam pattern to a desirable width. Memory 234 stores a multi-antenna precoder codebook 236 based on the parameterized beamforming weights as generated from beam control circuit 220.

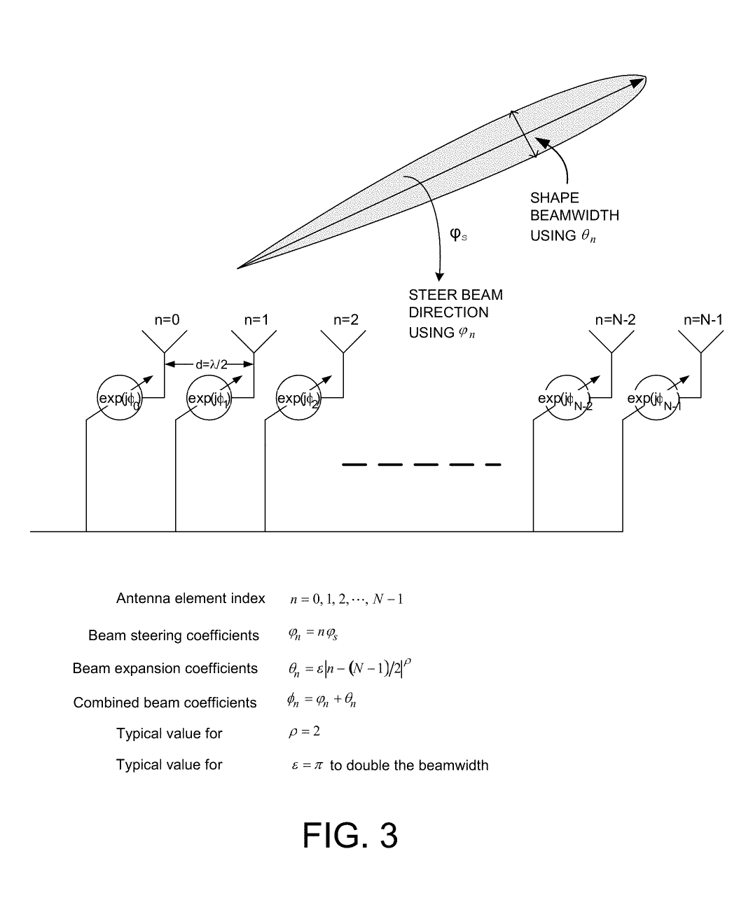

FIG. 3 illustrates a one embodiment of a transmitter or receiver having a phased antenna array 300 with N antenna elements to transmit or receive a directional beam, each antenna element is applied with a combined beam coefficient to steer the beam direction and to shape the beamwidth of the directional beam. Phased array antenna 300 has N antenna elements, indexed with n=0, 1, . . . N−1. In the most prevalent configuration, the N antenna elements forms a one-dimensional Uniform Linear Array with half a wavelength spacing. That is, each adjacent antenna element has a physical distance of d=(½)λ. Note that the one-dimensional array can be easily expanded to two-dimensional array. The N antenna elements are applied with a set of combined beam coefficients Φₙ to steer the direction of the beam and to shape the beamwidth to a desired width. Specifically, in addition to the original constant phase shift values φₙ from one antenna element to the next antenna element, additional phase modulation θₙ is applied to expand the beam to a desirable width.

In the example of FIG. 3, the original phase shift values φₙ form the directional narrow beam pattern and determine the general direction in which the beam is pointing to. The collection of the original phase modulation terms forming the narrow beam pattern is referred to as the beam steering coefficients. In one embodiment, φₙ=n*φₛ, where n is an antenna element index, and φₛ is a parameter used to steer the direction of the beam. Typically, φₛ has a value between 0 and 2π in the unit of radian.

The additional phase modulation terms θₙ expand the beam to a desirable width. The collection of the additional phase modulation terms is referred to as the beam expansion coefficients. The beam expansion coefficients for each of the antenna elements is derived from a formula that is a function of the antenna element's index and two parameters that control the shape and width of the beam. In one embodiment, θₙ=ε*|n−(N−1)/2|^{ρ}, where n is an antenna element index, a first parameter ε is used to shape the beamwidth of the directional beam, and a second parameter ρ is used to control a passband ripple of the directional beam. Typically, a larger value of parameter ε leads to a wider beamwidth, and ε=π approximately doubles the beamwidth of ε=0. The typical value for parameter ρ is set to ρ=2. It can be seen that the additional phase shift value θₙ for antenna element n is exponentially proportional to the distance between antenna element n and the middle point of the phased antenna array.

The combined beam coefficients are given by Φₙ=φₙ+θₙ. The combined beam coefficients can be further quantized in accordance with the processor that controls the antenna array. The beamforming weight vector of an N-element antenna array φ=[Φ₁, Φ₂ . . . Φ_{N}] is Φₙ=n*φₛ+ε*|n−(N−1)/2|^{ρ}. A multi-antenna precoder codebook based on the above parameterized beamforming weights design can be generated and stored in the memory of the wireless device. The codebook consists of a set of M beamforming weight vectors [Φ₁, Φ₂ . . . Φ_{M}] generated from a finite set of parameters [(φ_{s,1}, ε₁, ρ₁), (φ_{s,2}, ε₂, ρ₂) . . . (φ_{s,M}, ε_{M}, ρ_{M})]. Each of the M beamforming weight vector represent a beamforming weight design associate with a beam pattern having a beam direction, a shape, and a width.

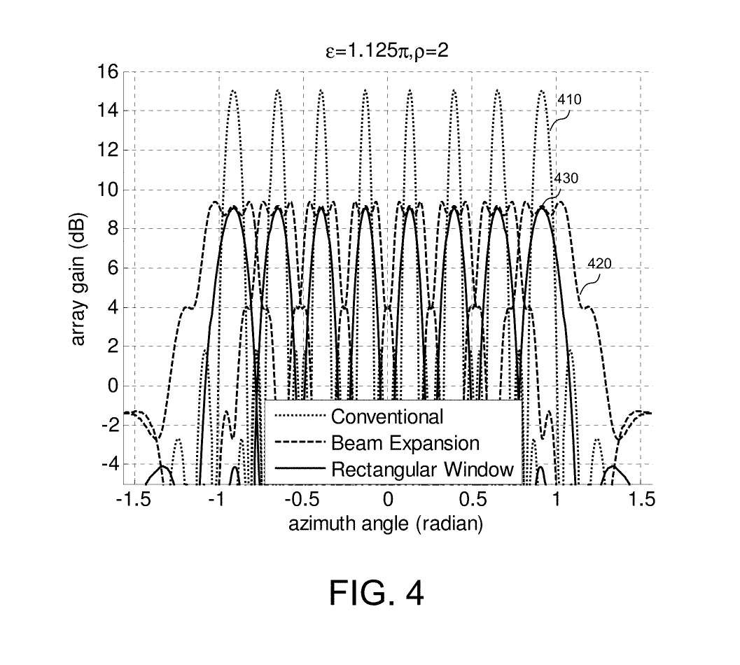

FIG. 4 illustrates the array gain and azimuth angle of a phased antenna array by comparing conventional beamforming, beamforming with beam expansion, and beamforming with rectangular window. As illustrated in FIG. 4, eight beams are to be formed in a 120° fan area by a 32-element antenna array. The horizontal axis represents the azimuth angle, which is associated with the beam steering parameter φₛ. The vertical axis represents the antenna array gain (dB). The dotted line 410 depicts the conventional beamforming applied only with beam steering coefficients, which creates eight beams with very large peak gain but also leaves many areas uncovered. The dashed line 420 depicts beamforming applied with phase shift modulation as well as amplitude modulation (e.g., the amplitudes across the antenna elements are derived from a rectangular windowing function)—the peak gain dropped by 6 dB but coverage improves slightly. The solid line 430 depicts beamforming applied with combined beam coefficients including both beam steering coefficients and beam expansion coefficients (e.g., with expansion parameters ε=1.125π, and ρ=2)—the coverage is much more uniform while the peak gain is the same as the amplitude windowing beamforming.

It can be seen that the advantages of beamforming applied with the combined beam coefficients are as follows. First, the forming of beam pattern can be adjusted with desirable beamwidth for a phased antenna array having multiple antenna elements. Second, the beamwidth of the beam pattern can be adjusted by changing only a few parameters. Third, the phased antenna array applied with the combined beam coefficients involve only phase shift, no amplitude modulation is needed and thereby increasing beamforming gain and efficiency.

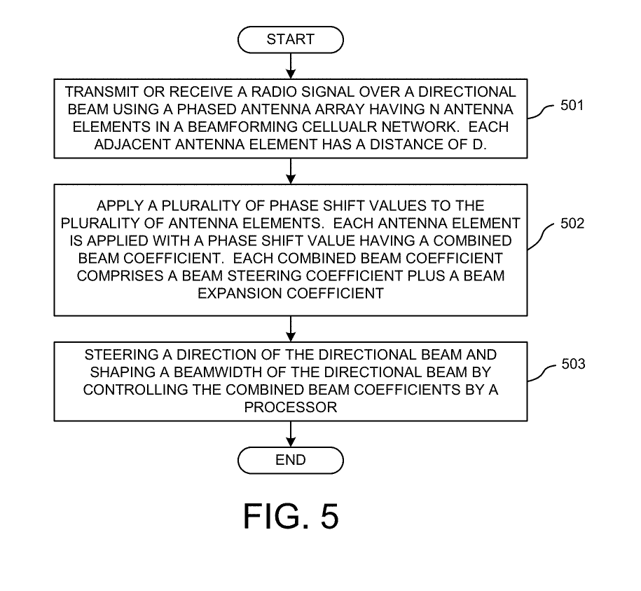

FIG. 5 is a flow chart of a method of steering beam direction and shaping beamwidth of a directional beam using a phased antenna array in a beamforming cellular system in accordance with one novel aspect. In step 501, a wireless device transmits or receives a radio signal over a directional beam using a phased antenna array having N antenna elements in a beamforming cellular network. Each adjacent antenna element has a distance of d, and N is a positive integer. In step 502, the wireless device applies a plurality of phase shift values to the plurality of antenna elements, each antenna element is applied with a phase shift value having a combined beam coefficient. Each combined beam coefficient comprises a beam steering coefficient plus a beam expansion coefficient. In step 503, the wireless device steers a direction of the directional beam and shapes a beamwidth of the directional beam by controlling the combined beam coefficients by a processor.

The beam steering coefficients φₙ are used to steer the direction of the directional beam, while the beam expansion coefficients θₙ are used to shape the beamwidth of the directional beam. The combined beam coefficients Φₙ=φₙ+θₙ. In one embodiment, φₙ=n*φₛ, where n is an antenna element index, and φₛ is a parameter used to steer the direction of the beam. Typically, φₛ has a value between 0 and 2π in the unit of radian. θₙ=ε*n−(N−1)/2|^{ρ}, where n is an antenna element index, a first parameter ε is used to shape the beamwidth of the directional beam, and a second parameter ρ is used to control a passband ripple of the directional beam. Typically, a larger value of parameter ε leads to a wider beamwidth, and ε=π approximately doubles the beamwidth of ε=0. The typical value for parameter ρ is set to ρ=2.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
transmitting or receiving a radio signal over a directional beam using a phased antenna array having N antenna elements in a beamforming cellular network, wherein adjacent antenna elements have a distance of d, wherein N is a positive integer;
applying a plurality of phase shift values to the plurality of antenna elements, wherein each antenna element is applied with a phase shift value having a combined beam coefficient, and wherein each combined beam coefficient comprises a beam steering coefficient plus a beam expansion coefficient; and
steering a direction of the directional beam and shaping a beamwidth of the directional beam by controlling the combined beam coefficients by a processor.

2. The method of claim 1, wherein the distance d is equal to half of a wavelength of the data signals.

3. The method of claim 1, wherein the beam steering coefficients are used to steer the direction of the directional beam.

4. The method of claim 3, wherein the beam steering coefficient φₙ=nφₛ, wherein n is an antenna element index, wherein φₛ is a value between 0 and 2π radian.

5. The method of claim 1, wherein the beam expansion coefficients are used to shape the beamwidth of the directional beam.

6. The method of claim 5, wherein the beam expansion coefficient θₙ=ε|n−(N−1)/2|^{ρ}, wherein n is an antenna element index, wherein ε is used to shape the beamwidth of the directional beam.

7. The method of claim 6, wherein a larger E leads to a wider beamwidth, and wherein ε=π approximately doubles the beamwidth of ε=0.

8. The method of claim 6, wherein ρ is used to control a passband ripple of the directional beam.

9. The method of claim 1, wherein the processor does not adjust amplitudes of the N antenna elements to maximize an array gain of the phased antenna array.

10. The method of claim 1, further comprising:
storing a multi-antenna precoder book of a finite set of beamforming weights based on the combined beam coefficients.

11. A wireless device, comprising:
a phased antenna array having N antenna elements that transmits or receives a radio signal over a directional beam in a beamforming cellular network, wherein adjacent antenna elements have a distance of d, wherein N is a positive integer;
a plurality of phase shifters coupled to the plurality of antenna elements, wherein each antenna element is applied with a phase shift having a combined beam coefficient, and wherein each combined beam coefficient comprises a beam steering coefficient plus a beam expansion coefficient; and
a processor that controls the combined beam coefficients to steer a direction and to shape a beamwidth of the directional beam.

12. The wireless device of claim 11, wherein the distance d is equal to half of a wavelength of the data signals.

13. The wireless device of claim 11, wherein the beam steering coefficients are used to steer the direction of the directional beam.

14. The wireless device of claim 13, wherein the beam steering coefficient φₙ=nφₛ, wherein n is an antenna element index, wherein φₛ is a value between 0 and 2π radian.

15. The wireless device of claim 11, wherein the beam expansion coefficients are used to shape the beamwidth of the directional beam.

16. The wireless device of claim 15, wherein the beam expansion coefficient θₙ=ε|n−(N−1)/2|^{ρ}, wherein n is an antenna element index, wherein ε is used to shape the beamwidth of the directional beam.

17. The wireless device of claim 16, wherein a larger ε leads to a wider beamwidth, and wherein ε=π approximately doubles the beamwidth of ε=0.

18. The wireless device of claim 16, wherein ρ is used to control a passband ripple of the directional beam.

19. The wireless device of claim 11, wherein the processor does not adjust amplitudes of the N antenna elements to maximize an array gain of the phased antenna array.

20. The wireless device of claim 11, wherein the device comprises memory that stores a multi-antenna precoder book of a finite set of beamforming weights based on the combined beam coefficients.
